(19) United States
(12) Patent Application Publication
(10) Pub. No.: US 2024/0020787 A1
(43) Pub. Date: Jan. 18, 2024

(54) IMAGING ELEMENT, IMAGING METHOD, IMAGING DEVICE, AND IMAGE PROCESSING SYSTEM

(71) Applicant: SONY SEMICONDUCTOR SOLUTIONS CORPORATION, KANAGAWA (JP)

(72) Inventor: TOSHIAKI NAKANO, KANAGAWA (JP)

(21) Appl. No.: 18/251,856

(22) PCT Filed: Nov. 4, 2021
(86) PCT No.: PCT/JP2021/040586

§ 371 Date: May 4, 2023

(30) Foreign Application Priority Data
Nov. 12, 2020 (JP) 2020-189017

(51) Int. Cl. G06T 1/00; H04N 23/80; G06V 20/00; G06F 21/64

(52) U.S. Cl. CPC G06T 1/005; H04N 23/80; G06V 20/95; G06F 21/64; G06T 2201/0065; G06T 2201/0061

(57) ABSTRACT

An imaging element (10) according to an embodiment includes an imaging unit (100) that outputs image information according to received light, an embedding information generation unit (1031) that obtains a feature amount of a predetermined area of an image based on the image information, determines whether to embed embedding information in the predetermined area based on the feature amount, and generates the embedding information based on the image information of the predetermined area into which the embedding information is determined to be embedded, and an embedding unit (1032) that embeds the embedding information, into the predetermined area.

### FIELD

The present disclosure relates to an imaging element, an imaging method, an imaging device, and an image processing system.

### BACKGROUND

Recent development of artificial intelligence (AI) and the like facilitates skillful falsification of still images and moving images. Against social problems in fake news or the like using a falsification image, the importance of image falsification detection has increased.

As a technology for image falsification detection, a technology of embedding an encryption code or the like in an original image, a technology of superimposing a digital watermark on an original image, and the like are known. In these technologies, if an image sensor and a processing unit that performs each processing are separated from each other, there is a possibility that a differential attack of, for example, taking over a communication channel between the image sensor and the processing unit may analyze the embedded or superimposed information. In addition, there is also a possibility that a falsified image is input to the processing unit and the falsified image may be guaranteed as an image not falsified, in the first place.

Therefore, a technology of using an image sensor and a processing unit that are integrally constituted has been proposed. For example, Patent Literature 1 describes a technology in which an image sensor includes a pixel substrate that includes a sensor unit, and a signal processing substrate on which an image information processing unit is arranged to process an electrical signal output from the sensor unit, the pixel substrate and the signal processing substrate being stacked and integrally configured in an image sensor, and identity between acquired image information and captured image information is guaranteed. According to the configuration of Patent Literature 1, falsification prevention processing is performed in the image sensor, and therefore, the image sensor is unlikely to have the differential attack.

### CITATION LIST

### Patent Literature

Patent Literature 1: JP 2017-184198 A

### SUMMARY

### Technical Problem

However, even in the configuration in which the falsification prevention processing is performed in the image sensor, there is a possibility that an intentional input image such as a saturated image or an image with a low gain is generated against the falsification prevention processing, and the differential attack may analyze embedding information by the falsification prevention processing.

The present disclosure provides an imaging element, an imaging method, an imaging device, and an image processing system that enable falsification prevention processing with higher resistance against attack.

### Solution to Problem

For solving the problem described above, an imaging element according to one aspect of the present disclosure has an imaging unit that outputs image information according to received light; an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded; and an embedding unit that embeds the embedding information, into the predetermined area.

For solving the problem described above, an imaging method according to one aspect of the present disclosure comprises, performed by a processor: an imaging step of outputting image information according to received light; an embedding information generation step of obtaining a feature amount of a predetermined area of an image based on the image information, determining whether to embed embedding information in the predetermined area based on the feature amount, and generating the embedding information based on the image information of the predetermined area into which the embedding information is determined to be embedded; and an embedding step of embedding the embedding information, into the predetermined area.

For solving the problem described above, an imaging device according to one aspect of the present disclosure has an imaging unit that outputs image information according to received light; an optical unit that guides light from a subject to the imaging unit; an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded; an embedding unit that embeds the embedding information, into the predetermined area; and a recording unit that records the image information into which the embedding information is embedded by the embedding unit.

For solving the problem described above, an image processing system according to one aspect of the present disclosure has an image processing apparatus; and an information processing apparatus that is connected to the image processing apparatus via a network, wherein the information processing apparatus includes a falsification detection unit that, based on a feature amount of a predetermined area of an image, acquires image information of an image for which whether to embed embedding information in the predetermined area, from the image processing apparatus through the network, extracts the embedding information from the acquired image information, detects presence or absence of falsification against the image information based on the extracted embedding information, adds falsification detection information indicating presence or absence of the detected falsification to the image information, and transmits the falsification detection information to the image processing apparatus, and the image processing apparatus includes an image processing unit that, when the falsification presence/absence information added to the image information transmitted from the information processing apparatus indicates absence of the falsification, performs image processing on the image information, performs image falsification prevention processing on the image information subjected to the image processing, and, when the falsification presence/absence information indicates presence of the falsification, adds information indicating presence of the falsification in the image information.

### BRIEF DESCRIPTION OF DRAWINGS

FIG. 1 is a diagram schematically illustrating an embedding process for embedding information according to each embodiment of the present disclosure.

FIG. 2 is a diagram illustrating an effect according to each embodiment of the present disclosure.

FIG. 3 is a block diagram schematically illustrating a configuration of an imaging device applicable to each embodiment of the present disclosure.

FIG. 4 is a block diagram illustrating an exemplary configuration of an imaging element applicable to each embodiment.

FIG. 5A is a diagram illustrating an example of the imaging element including a stacked CIS having a two-layer structure according to each embodiment.

FIG. 5B is a diagram illustrating an example of the imaging element including a stacked CIS having a three-layer structure according to each embodiment.

FIG. 6 is an exemplary functional block diagram illustrating functions of an imaging element according to a first embodiment.

FIG. 7 is an exemplary flowchart illustrating an embedding process for embedding information according to the first embodiment.

FIG. 8 is a schematic diagram illustrating an example of block division processing performed by a block division unit, according to the first embodiment.

FIG. 9 is a diagram schematically illustrating blocks having a feature amount exceeding a threshold and blocks having a feature amount equal to or less than the threshold in blocks obtained by dividing an image.

FIG. 10 is a diagram schematically illustrating the presence or absence of embedding information in each block 51 obtained by dividing the image.

FIG. 11 is a schematic diagram illustrating feature amount calculation by an embedding unit, according to the first embodiment.

FIG. 12 is an exemplary flowchart illustrating processing of generating and embedding embedding information according to the first embodiment.

FIG. 13 is a schematic diagram illustrating calculation of a total value of data in a block, according to the first embodiment.

FIG. 14 is a diagram schematically illustrating an example of lower 2 bits of a total value sum acquired as the embedding information, according to the first embodiment.

FIG. 15 is a schematic diagram illustrating an example of output information including falsification inspection information generated by the embedding unit, according to the first embodiment.

FIG. 16 is an exemplary functional block diagram illustrating functions of an imaging element according to a first modification of the first embodiment.

FIG. 17 is an exemplary flowchart illustrating an embedding process for embedding information according to the first modification of the first embodiment.

FIG. 18 is a schematic diagram illustrating an example of a result of object detection processing on an image by an object detection unit, according to the first modification of the first embodiment.

FIG. 19 is an exemplary functional block diagram illustrating functions of an imaging element according to a second modification of the first embodiment.

FIG. 20 is a schematic diagram illustrating an example of a result of object detection processing and block division processing on an image according to the second modification of the first embodiment.

FIG. 21A is a schematic diagram illustrating a problem of a falsification prevention technology according to an existing technology.

FIG. 21B is a schematic diagram illustrating a problem of the falsification prevention technology according to an existing technology.

FIG. 22 is a diagram illustrating an exemplary configuration for falsification detection and prevention, according to a second embodiment.

FIG. 23 is an exemplary flowchart schematically illustrating a falsification detection and prevention process according to the second embodiment.

FIG. 24 is an exemplary flowchart illustrating processing according to the second embodiment in more detail.

FIG. 25 is an exemplary flowchart illustrating processing in a PC that has received a result of determination of the presence or absence of falsification from a server, according to the second embodiment.

FIG. 26 is an exemplary flowchart illustrating processing according to a modification of the second embodiment in more detail.

### DESCRIPTION OF EMBODIMENTS

Embodiments of the present disclosure will be described in detail below with reference to the drawings. Note that in the following embodiments, the same portions are denoted by the same reference numerals and symbols, and redundant description thereof will be omitted.

Hereinafter, the embodiments of the present disclosure will be described in the following order.
1. Overview of present disclosure
2. Configuration applicable to each embodiment of present disclosure
3. First embodiment of present disclosure
3-1. Configuration according to first embodiment
3-2. Details of processing according to first embodiment
3-3. First modification of first embodiment
3-4. Second modification of first embodiment
4. Second embodiment of present disclosure
4-1. Existing technology
4-2. Configuration according to second embodiment
4-3. Details of processing according to second embodiment
4-4. Modifications of second embodiment

### 1. Overview of Present Disclosure

First, an outline of the present disclosure will be described. The present disclosure relates to a technology of embedding digital watermark information for preventing falsification, as embedding information, in a captured image (image information) captured by an imaging element.

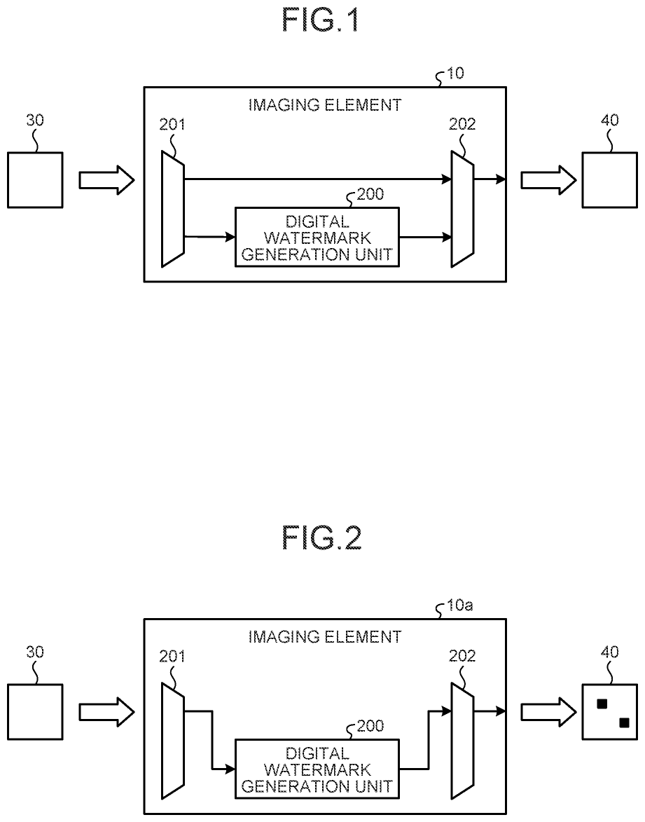

FIG. 1 is a diagram schematically illustrating an embedding process for embedding information according to each embodiment of the present disclosure. In each embodiment of the present disclosure, an imaging element 10 includes an imaging unit (not illustrated) that outputs a captured image as image information, according to received light, and a digital watermark generation unit 200 that generates the embedding information for embedding in the image information on the basis of the image information.

More specifically, in the imaging element 10, the captured image of a subject 30 captured by the imaging unit is supplied to the digital watermark generation unit 200 and an embedding unit 202 via an input unit 201. The digital watermark generation unit 200 determines a predetermined area into which the embedding information is embedded in the captured image, on the basis of a feature amount of the predetermined area. Furthermore, the digital watermark generation unit 200 generates the embedding information, as the digital watermark information, on the basis of the captured image supplied from the input unit 201. The embedding information and the information about the predetermined area into which the embedding information is embedded are passed to the embedding unit 202.

The embedding unit 202 embeds the embedding information, in the image information supplied from the input unit 201, on the basis of the embedding information and the information about the predetermined area into which the embedding information is embedded, passed from the digital watermark generation unit 200. The embedding unit 202 outputs the image information in which the embedding information has been embedded, as output information 40.

According to each embodiment of the present disclosure configured as described above, the embedding information for detecting the presence or absence of falsification of the captured image information is incorporated in the imaging element 10, together with the imaging unit, preventing takeover of the image information. At the same time, the imaging element determines the predetermined area into which the embedding information is embedded, on the basis of the feature amount of the predetermined area, and therefore, it is possible to resist a differential attack using a saturated image or the like.

FIG. 2 is a diagram illustrating an effect according to each embodiment of the present disclosure. An imaging element illustrated in FIG. 2 is configured to embed the embedding information, in the entire captured image of the subject 30. In this configuration, when the saturated image or a captured image captured on imaging conditions of low gain and extremely low noise is created, a position where the embedding information has been embedded may be readily analyzed by the differential attack or the like.

Therefore, in each embodiment of the present disclosure, as described with reference to FIG. 1, the embedding unit 202 determines whether to embed the embedding information, in the predetermined area, on the basis of the feature amount of the predetermined area of the image based on the image information directly transferred from the input unit 201 to the embedding unit 202, and is configured not to embed the embedding information, in a portion other than the predetermined area into which the embedding information is determined to be embedded. Therefore, the risk of the differential attack can be reduced.

An image falsification prevention technology according to the present disclosure is preferably applied to, for example, an image or video for important use that affects the life of a person. For example, the image falsification prevention technology is considered to be applied to falsification prevention of a captured image of a monitoring camera that can be used as an evidence image of a crime or the like.

Furthermore, in a field where medical image of an endoscope or digital X-ray imaging device is handled, the image falsification prevention technology is also considered to be applied to falsification prevention of association with an image of an electronic medical record or a user ID in remote medical care or the like. Note that the application of the image falsification prevention technology according to the present disclosure is not limited thereto.

### 2. Configuration Applicable to Each Embodiment of Present Disclosure

Next, a configuration applicable to each embodiment of the present disclosure will be described.

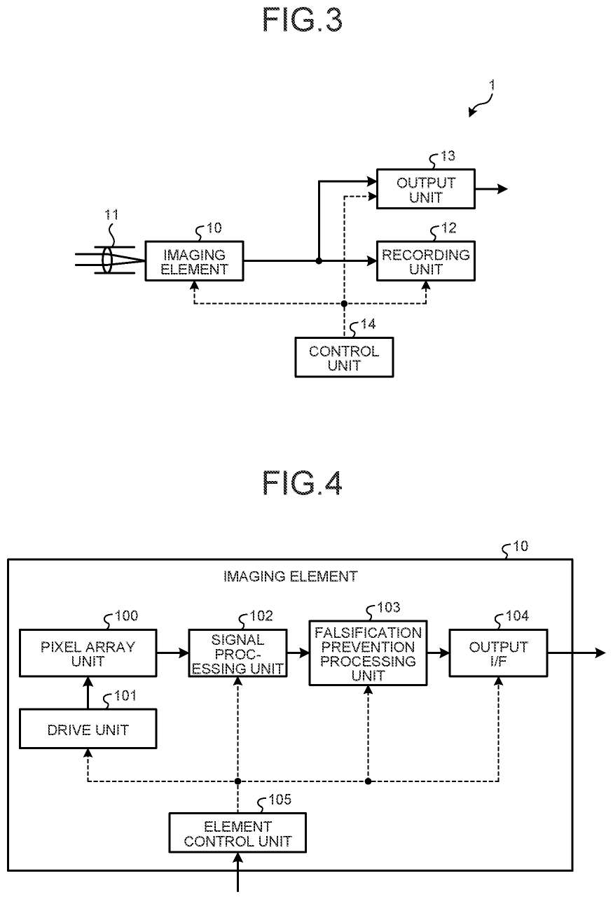

FIG. 3 is a block diagram schematically illustrating a configuration of an imaging device applicable to each embodiment of the present disclosure. In FIG. 3, An imaging device 1 includes the imaging element 10, an optical unit 11, a recording unit 12, an output unit 13, and a control unit 14.

The imaging element 10 has a light receiving surface and converts an analog image signal according to light received by the light receiving surface into digital image data, and outputs the image data as the image information. The optical unit 11 is provided to apply light from the subject to the light receiving surface of the imaging element 10, and includes one or more lenses, a focus mechanism, a diaphragm mechanism, and the like. For example, a nonvolatile recording medium such as a hard disk drive or flash memory is applicable to the recording unit 12, and is configured to record the image information output from the imaging element 10.

The output unit 13 is an interface for outputting the image information output from the imaging element 10 to the outside of the imaging device 1. The output unit 13 may be connected to an external device through wired communication using a cable or wireless communication. Furthermore, the output unit 13 may be configured to be connected to an external network such as the Internet or a local area network (LAN).

The control unit 14 controls the operations of the entire imaging device 1. For example, the control unit 14 includes a central processing unit (CPU), and memories such as a read only memory (ROM) and a random access memory (RAM), and controls the entire operations of the imaging device 1 by using the RAM as a work memory, for example, according to programs stored in the ROM. Furthermore, the control unit 14 is configured to generate a clock for driving the imaging element 10 or the like.

FIG. 4 is a block diagram illustrating an exemplary configuration of the imaging element 10 applicable to each embodiment. In FIG. 4, the imaging element 10 includes a pixel array unit 100, a drive unit 101, a signal control unit 102, a falsification prevention processing unit 103, an output I/F 104, and an element control unit 105.

The element control unit 105 includes, for example, a processor, and controls the operations of the entire imaging element 10 according to an instruction from the control unit 14. Furthermore, the element control unit 105 generates a clock signal used by the drive unit 101 to drive the pixel array unit 100.

The pixel array unit 100 includes a pixel array having pixel circuits arranged in a matrix array, pixel circuits each including a light receiving element such as a photodiode that generates a charge according to light received by photoelectric conversion, and a reading circuit that converts the charge generated by the light receiving element into a pixel signal being an electric signal and that reads the pixel signal. The pixel array unit 100 further includes a conversion unit that converts the analog pixel signal read from each pixel circuit into the digital image data (image information).

The drive unit 101 controls exposure and read operations in the pixel array unit 100 on the basis of the clock signal supplied from the element control unit 105. The image information output from the pixel array unit 100 is passed to the signal processing unit 102. The signal processing unit 102 performs predetermined signal processing on the image information passed from the pixel array unit 100. The signal processing unit 102 performs, for example, level adjustment processing, white balance adjustment processing, and the like, on the image information.

The falsification prevention processing unit 103 performs the falsification prevention processing according to each embodiment of the present disclosure, on the image information subjected to the signal processing by the signal processing unit 102. More specifically, the falsification prevention processing unit 103 generates the embedding information on the basis of the image information, embeds the generated embedding information in the predetermined area of the image based on the image information, and the like.

The output I/F 104 is an interface for outputting the image information subjected to the falsification prevention processing by the falsification prevention processing unit 103, to the outside of the imaging element 10. As the output I/F 104, for example, Mobile Industry Processor Interface (MIPI) can be applied.

To the imaging element 10, a CMOS image sensor (CIS) can be applied that is obtained by integrally forming the units included in the imaging element 10 by using a complementary metal oxide semiconductor (CMOS). The imaging element 10 can be formed on a single substrate. The imaging element 10 is not limited to this configuration and may have a stacked CIS in which a plurality of semiconductor chips is stacked and integrally formed. Note that the imaging element 10 is not limited to this example, and may be another type of optical sensor such as an infrared sensor that performs imaging using infrared light.

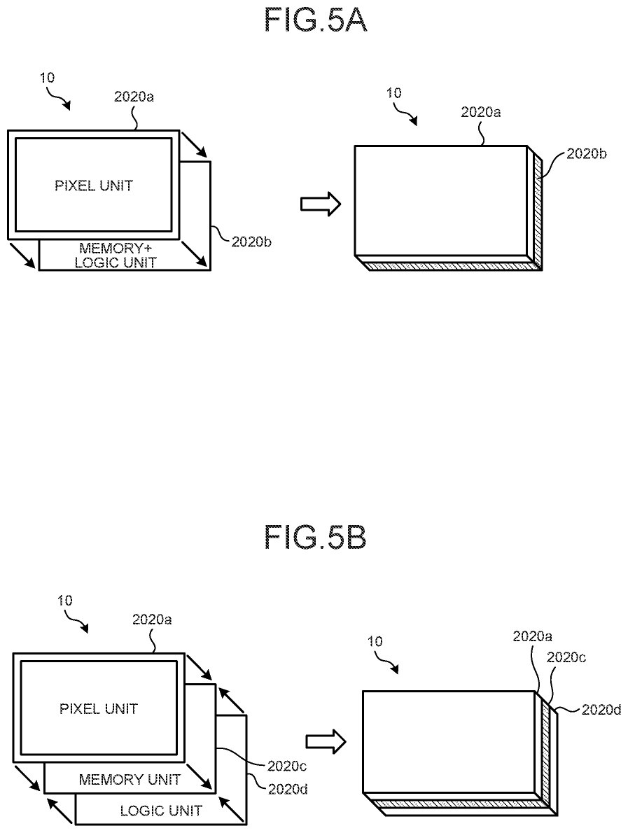

In an example, the imaging element 10 can be formed by a stacked CIS having a two-layer structure in which the semiconductor chips are stacked in two layers. FIG. 5A is a diagram illustrating an example of the imaging element 10 including the stacked CIS having the two-layer structure according to each embodiment. In the structure of FIG. 5A, a pixel unit 2020a is formed in a semiconductor chip in a first layer, and a memory+logic unit 2020b is formed in a semiconductor chip in a second layer.

The pixel unit 2020a includes at least the pixel array unit 100 in the imaging element 10. The memory+logic unit 2020b can include, for example, the drive unit 101, the signal control unit 102, the falsification prevention processing unit 103, the output I/F 104, and the element control unit 105. The memory+logic unit 2020b can further include a memory that stores the image information.

As illustrated on the right side of FIG. 5A, the semiconductor chip in the first layer and the semiconductor chip in the second layer are electrically contacted and bonded to each other to constitute the imaging element 10 as a single solid-state image sensor.

In another example, the imaging element 10 can be formed into a three-layer structure in which the semiconductor chips are stacked in three layers. FIG. 5B is a diagram illustrating an example of the imaging element 10 including a stacked CIS having the three-layer structure according to each embodiment. In the structure of FIG. 5B, the pixel unit 2020a is formed in a semiconductor chip in a first layer, a memory unit 2020c is formed in a semiconductor chip in a second layer, and a logic unit 2020d is formed in a semiconductor chip in a third layer. In this configuration, the logic unit 2020d can include, for example, the drive unit 101, the signal control unit 102, the falsification prevention processing unit 103, the output I/F 104, and the element control unit 105. Furthermore, the memory unit 2020c can include a memory that stores the image information.

As illustrated on the right side of FIG. 5B, the semiconductor chip in the first layer, the semiconductor chip in the second layer, and the semiconductor chip in the third layer are electrically contacted and bonded to each other to constitute the imaging element 10 as a single solid-state image sensor.

### 3. First Embodiment of Present Disclosure

(3-1. Configuration According to First Embodiment)

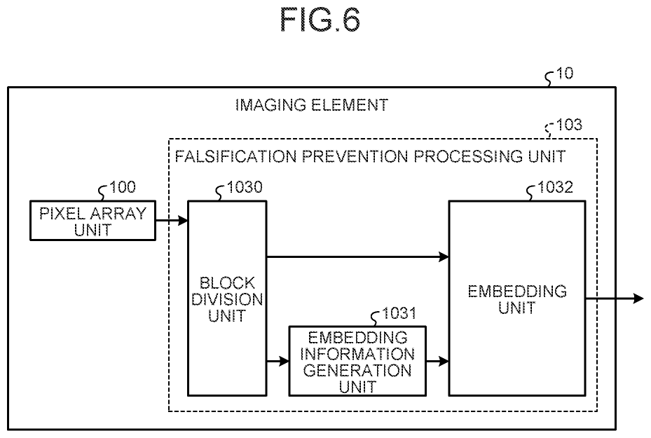

Next, a first embodiment of the present disclosure will be described. FIG. 6 is an exemplary functional block diagram illustrating functions of the imaging element 10 according to the first embodiment. Note that, in FIG. 6, of the configuration illustrated in FIG. 4, the drive unit 101, the signal processing unit 102, the output I/F 104, and the element control unit 105 do not closely relate to processing according to the first embodiment, and are omitted in order to avoid complication.

In FIG. 6, the falsification prevention processing unit 103 includes a block division unit 1030, an embedding information generation unit 1031, and an embedding unit 1032. The block division unit 1030, the embedding information generation unit 1031, and the embedding unit 1032 are each implemented, for example, by executing a predetermined program on a processor of the imaging element 10. The present disclosure is not limited to this configuration, and some or all of the block division unit 1030, the embedding information generation unit 1031, and the embedding unit 1032 may be implemented by hardware circuits that operate in cooperation with each other.

The block division unit 1030 corresponds to the input unit 201 in FIG. 1, and divides an image based on the image information supplied from the pixel array unit 100, into blocks each including a plurality of pixels. The blocks obtained by dividing the image by the block division unit 1030 are passed to the embedding unit 1032 and the embedding information generation unit 1031.

The embedding information generation unit 1031 corresponds to the digital watermark generation unit 200 in FIG. 1, and selects a block into which the embedding information is embedded, from among the blocks passed from the block division unit 1030. The embedding unit 1032 obtains the feature amount for each of the blocks on the basis of a pixel value of each pixel included in each block, and determines whether to embed the embedding information for each block, on the basis of each obtained feature amount.

As the feature amount used by the embedding information generation unit 1031 to determine whether to embed the embedding information, a dispersion of the pixel values of the pixels included in the block can be applied. As the dispersion, a dispersion value, a standard deviation value, a range, and the like are allowed to be used. The feature amount is not limited thereto, and is allowed to use an average value. In addition, a relative value with respect to the maximum output value may be used.

The embedding information generation unit 1031 compares the obtained feature amount with a threshold and performs threshold determination. The embedding information generation unit 1031 determines, of the blocks passed from the block division unit 1030, a block in which the obtained dispersion exceeds a threshold, as a block into which the embedding information is embedded. The threshold is preferably optimized according to a use case in which falsification is desired to be prevented.

As described above, the embedding information generation unit 1031 sets the block having a feature amount exceeding the threshold, as the block into which the embedding information is embedded, and sets a block having a feature amount equal to or less than the threshold, as a block in which no embedding information is embedded. Therefore the embedding information is prevented from being embedded in a flat portion of the image, and resistance to the differential attack can be enhanced.

Furthermore, the embedding information generation unit 1031 generates the embedding information, on the basis of each block passed from the block division unit 1030. The embedding information generation unit 1031 generates information for identifying the image information, as the embedding information, on the basis of the image information output from the pixel array unit 100.

For example, the embedding information generation unit 1031 is configured to generate a cyclic redundancy check (CRC) value, a hash value, a total value of the pixel values, or the like, on the basis of the pixel values of the pixels included in each block, and generate the embedding information using the generated value. In this configuration, for example, when pixel data of each pixel has a bit length of m bits, the embedding information can be generated by using values from the most significant bit to, for example, an (m−1) bit. The generation of the embedding information is processing corresponding to, for example, embedding the embedding information into a bit position of the least significant bit in the embedding process for embedding information which is described later.

The present disclosure is not limited to this configuration, and in the embedding information generation unit 1031, the embedding information can also include supplementary information such as an imaging element ID for identification of the imaging element 10 itself, information indicating the imaging time and an imaging location at which an image has been captured from outside, and a program ID for identification of a program for implementing the embedding information generation unit 1031. The embedding information generated by the embedding information generation unit 1031 is passed to the embedding unit 1032.

The embedding unit 1032 embeds the embedding information that is generated by the embedding information generation unit 1031, into the block into which the embedding information is determined to be embedded by the embedding information generation unit 1031. At this time, the embedding unit 1032 embeds the embedding information into a pixel (referred to as specific pixel) at a predetermined position, of the plurality of pixels included in the block. Furthermore, the embedding unit 1032 embeds the embedding information into the least significant bit of the specific pixel. The embedding unit 1032 is not limited to this configuration, and can also embed the embedding information, at a bit positioned a plurality of bits (e.g., 2 bits) away from the least significant bit so as not to affect the image.

(3-2. Details of Processing According to First Embodiment)

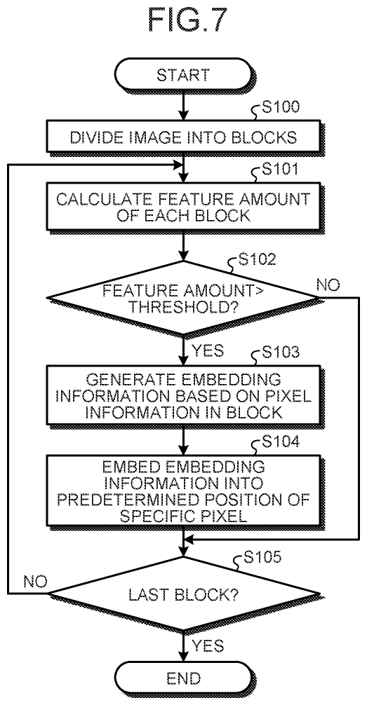

Next, the processing according to the first embodiment will be described in more detail with reference to FIGS. 7 to 15. FIG. 7 is an exemplary flowchart illustrating the embedding process for embedding information according to the first embodiment. In Step S100, the falsification prevention processing unit 103 divides the image based on the image information supplied from the pixel array unit 100 into blocks, by using the block division unit 1030.

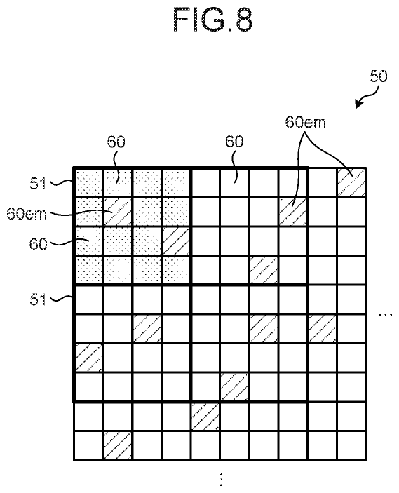

FIG. 8 is a schematic diagram illustrating an example of block division processing performed by the block division unit 1030, according to the first embodiment. In the example of FIG. 8, an image 50 based on the image information is divided into blocks 51 each including 16 pixels 60 of 4 pixels×4 pixels. Note that a pixel 60em indicates a pixel that is determined in advance to embed the embedding information. Hereinafter, the pixel 60em determined in advance to embed the embedding information is appropriately referred to as specific pixel 60em. In the example of this drawing, each of the blocks 51 includes two specific pixels 60em. Each of the divided blocks 51 is passed to the embedding unit 1032 and the embedding information generation unit 1031.

Next, in Step S101 of FIG. 7, the falsification prevention processing unit 103 calculates the feature amount of each block 51, by using the embedding information generation unit 1031.

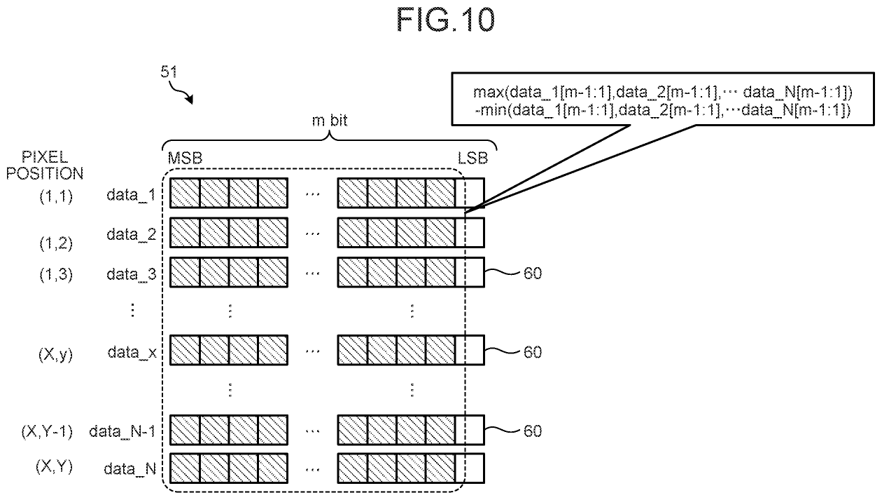

FIG. 10 is a schematic diagram illustrating feature amount calculation by the embedding information generation 1031, according to the first embodiment. The left end of the drawing illustrates a pixel position (x, y) in the block 51, and the pixels 60 including the specific pixels 60em (not illustrated) are data data_1, data data_2, data data_3, . . . , data data_x, . . . , data data_N−1, and data data_N, from right to left in rows and from the top row to the bottom row. Note that, in this example, N=16.

In the drawing, each of the data data_1 to data_N has a data length of m bits. The embedding information generation unit 1031 calculates the feature amount on the basis of values [m−1:1] from the most significant bit (MSB) to the (m−1) bit of the respective data data_1 to data_N. In this example, for the sake of description, it is assumed that the feature amount is calculated using range, and the embedding information generation unit 1031 calculates, as the feature amount, a difference between a maximum value [m−1:1] and a minimum value [m−1:1], on the basis of a value [m−1:1] of each pixel 60 included in the block 51.

Next, in Step S102 of FIG. 7, the falsification prevention processing unit 103 compares the feature amount obtained in Step S101 with the threshold, and determines whether the feature amount exceeds the threshold, by using the embedding information generation unit 1031. A block 51 having a feature amount exceeding the threshold is set as a target block 51 into which the embedding information is embedded. When the falsification prevention processing unit 103 determines that the feature amount is equal to or less than the threshold, by using the embedding information generation unit 1031 (Step S102, “No”), the process proceeds to Step S105. On the other hand, when the falsification prevention processing unit 103 determines that the feature amount exceeds the threshold, by using the embedding information generation unit 1031 (Step S102, “Yes”), the process proceeds to Step S103.

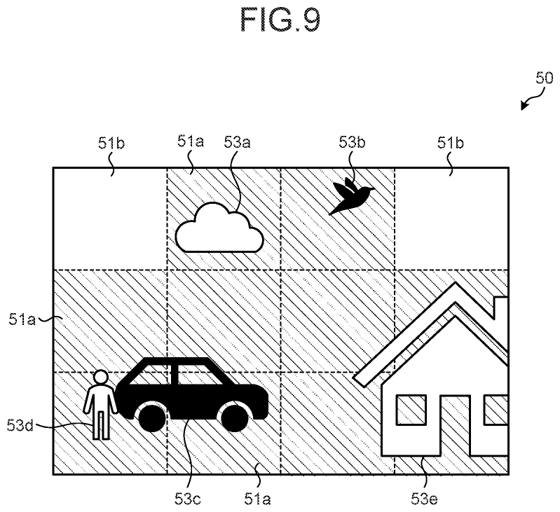

FIG. 9 is a diagram schematically illustrating blocks 51a each having a feature amount exceeding the threshold and blocks 51b each having a feature amount equal to or less than the threshold in the blocks 51 obtained by dividing the image 50. In the example of FIG. 9, the image 50 includes objects 53a, 53b, 53c, 53d, and 53e against a flat background. In this example, the blocks 51a including at least part of the objects 53a to 53e are the target blocks each of which has a feature amount exceeding the threshold and into which the embedding information is embedded. Meanwhile, the blocks 51b not including the objects 53a to 53e at all have a feature amount equal to or less than the threshold, and are not the target blocks into which the embedding information is embedded.

In Step S103 of FIG. 7, the falsification prevention processing unit 103 generates the embedding information on the basis of pixel information in a target block 51a for embedding, into which the embedding information is embedded, by using the embedding information generation unit 1031. The embedding information generation unit 1031 passes information indicating the target block 51a for embedding and the generated embedding information to the embedding unit 1032. In the next Step S104, the falsification prevention processing unit 103 embeds the embedding information generated in Step S103 into a predetermined position of the specific pixel 60em, by using the embedding unit 1032. Note that the processing is skipped in the blocks 51b that are not the target for embedding the embedding information.

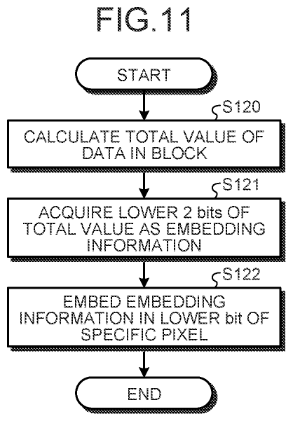

The processing of generating the embedding information performed in Step S103 and the processing of embedding the embedding information into the specific pixel 60em performed in step S104 in the flowchart of FIG. 7 will be specifically described with reference to FIGS. 11 to 14.

FIG. 11 is an exemplary flowchart illustrating the processing of generating and embedding the embedding information according to the first embodiment. Here, generation of the embedding information based on the total value of the pixel values of the respective pixels 60 (including the specific pixels 60em) included in the block 51a will be described.

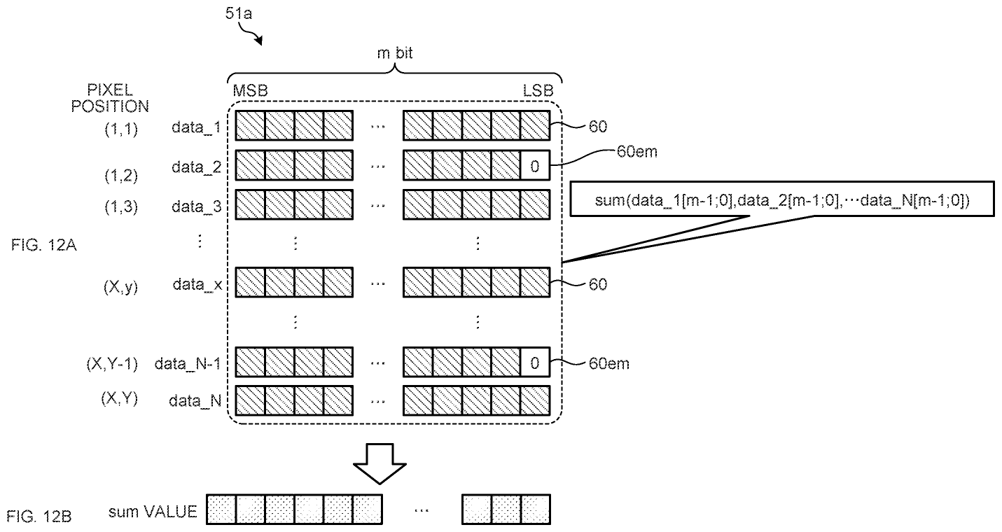

In Step S120, the falsification prevention processing unit 103 calculates a total value of the data in the target block 51a, by using the embedding information generation unit 1031. FIG. 12 is a schematic diagram illustrating calculation of a total value of the data in the block 51a, according to the first embodiment. Note that, in FIG. 12, the meaning of each portion of a section (a) is similar to that of each portion of FIG. 10 described above, and thus the description thereof will be omitted here.

As illustrated in the section (a) of FIG. 12, the embedding information generation unit 1031 calculates a total value sum of values of data data_1 to data_N each having a bit length of m bits, for the respective pixels 60 including the specific pixels 60em in the block 51a. At this time, for the specific pixel 60em, the total value sum is calculated with the value of the bit position (the least significant bit in this example) into which the embedding information is embedded as “0.” A section (b) of FIG. 12 is a diagram schematically illustrating the total value sum (illustrated as sum value in the drawing) calculated by the embedding information generation unit 1031. The total value sum may have a bit length longer than m bits of the bit length of each of the data data_1 to data_N, depending on the value of each of the data data_1 to data_N summed.

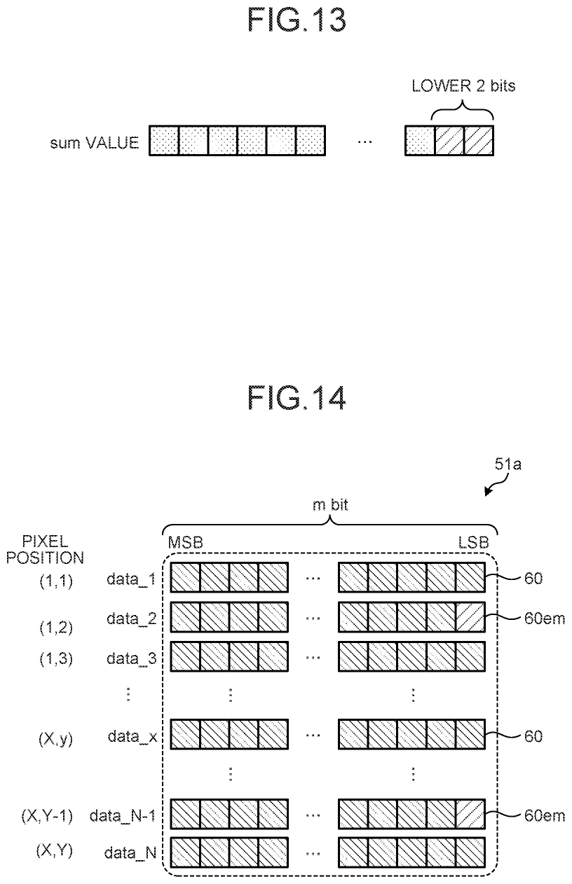

In Step S121 of FIG. 11, the falsification prevention processing unit 103 acquires the lower 2 bits of the total value sum as the embedding information, by using the embedding information generation unit 1031, as schematically illustrated in FIG. 13. FIG. 13 is a diagram schematically illustrating an example of the lower 2 bits of the total value sum acquired as the embedding information, according to the first embodiment. The embedding information generation unit 1031 passes the acquired embedding information and information indicating the block 51a from which the embedding information is acquired, to the embedding unit 1032.

In Step S122 of FIG. 11, the falsification prevention processing unit 103 embeds the embedding information, into the lower bit of each specific pixel 60em, as the predetermined position, by using the embedding unit 1032. FIG. 14 is a diagram schematically illustrating a state where the embedding information is embedded into the lower bit of each specific pixel 60em, according to the first embodiment.

In this example, 1 bit of the embedding information is embedded in the least significant bit of each specific pixel 60em. For example, in a case where two specific pixels 60em are set in the block 51a, the embedding information of 2 bits can be embedded in the block 51a. This is the reason why the lower 2 bits of the total value sum are acquired as the embedding information in Step S121.

Note that, here, the lower 2 bits of the total value sum are, not limited to this example, acquired as the embedding information, but bits higher than the lower 2 bits of the total value sum, for example, the lower 3 bits or the lower 4 bits may be acquired as the embedding information.

Furthermore, here, the embedding information acquired from the target block 51a is configured to be embedded in this target block 51a, but is not limited to this example. In other words, the embedding information acquired from a certain block 51a may be embedded in the specific pixel 60em of another block 51a different from the block 51a. This configuration makes it possible to more firmly prevent falsification.

Returning to FIG. 7, when the embedding information is acquired and embedded in the specific pixel 60em in Steps S103 and S104 in FIG. 7, as described with reference to FIGS. 11 to 14, the process proceeds to Step S105. In Step S105, the falsification prevention processing unit 103 determines whether the block 51 processed in Steps S101 to S104 is the last block processed in the image 50. When the falsification prevention processing unit 103 determines that the block is not the last block (Step S105, “No”), the process returns to Step S101 and the processing of a next block 51 in the image 50 is performed. On the other hand, when the falsification prevention processing unit 103 determines that the block is the last block (Step S105, “Yes”), a series of process steps according to the flowchart of FIG. 7 is finished.

When the process according to the flowchart of FIG. 7 is completed, the falsification prevention processing unit 103 generates information about the embedding information, adds the generated information to the image information of the image 50, and generates output information, by using the embedding unit 1032. For example, when the image 50 is used, the embedding information is restored using this information, and whether the image 50 is falsified is inspected. Hereinafter, the information about the embedding information added to the image information is referred to as falsification inspection information.

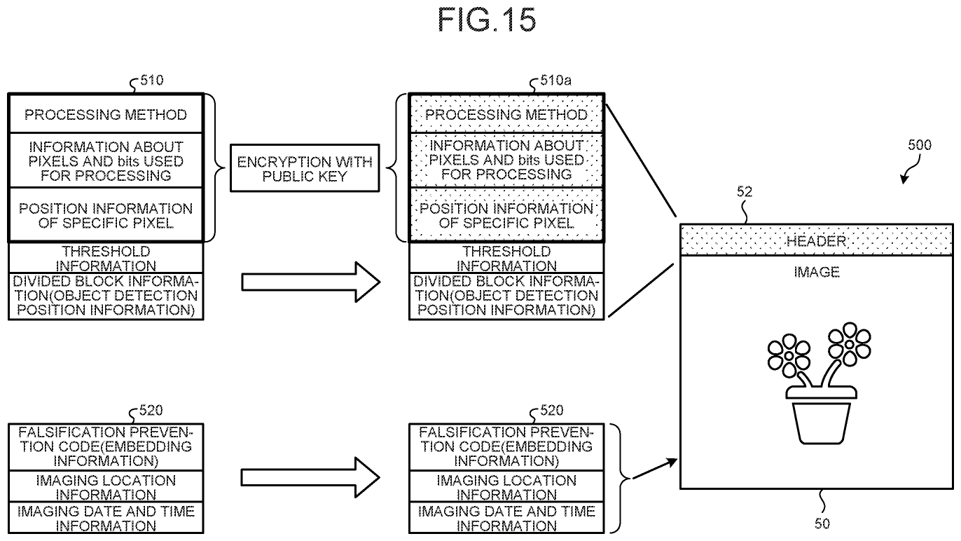

FIG. 15 is a schematic diagram illustrating an example of output information 500 including the falsification inspection information output by the embedding unit 1032, according to the first embodiment.

The left side of FIG. 15 illustrates an example of a falsification inspection information 510 and a falsification prevention code 520 that is the embedding information, included in the output information 500, and the center portion of FIG. 15 illustrates an example of encrypted falsification inspection information 510a in which part of the falsification inspection information 510 is encrypted. The right side of FIG. 15 illustrates an example of the output information 500 in which the encrypted falsification inspection information 510a and the falsification prevention code 520 are added to the image 50. In the example of FIG. 15, the encrypted falsification inspection information 510a is added to the image 50, as header information 52. Note that the image 50 itself is omitted on the left side and the center portion of FIG. 15.

In the example of FIG. 15, the falsification inspection information 510 includes a processing method, information about pixels and bits used for the processing, position information of the specific pixel, threshold information, and divided block information.

The processing method indicates a processing method (method of obtaining the CRC value, hash value, total value, or feature amount, or the like) used to generate the embedding information in Step S103 in FIG. 7. The information about pixels and bits used for the processing indicates information about pixels used to generate the embedding information and bits of the pixel values of the pixels used for the processing. For example, all the pixels in the block 51 are used, values up to (m−1) bits of the pixel value of m bits of each pixel are used, or the like. The position information of the specific pixel indicates position information of each specific pixel 60em into which the embedding information is embedded, in the image 50, the position information being arranged in the image 50. As described above, addition of the position information of the specific pixel to the falsification inspection information 510 makes it possible to differ the position of the specific pixel 60em for each image 50.

Note that, in a case where the processing method, the information about pixels and bits used for the processing, and the position information of the specific pixel are set to be fixed in default information for each image 50, the information can be omitted. The fixed information can be omitted, so that an encryption processing time may be reduced or deleted.

In the falsification inspection information 510, the threshold information indicates the threshold for comparison with the feature amount in Step S102 in the flowchart of FIG. 7. The divided block information is information about each block 51 obtained by dividing the image 50 in Step S100 in the flowchart of FIG. 7, and indicates, for example, the size of the block (4 pixels×4 pixels etc.). In modifications of the first embodiment which is described later, information indicating a position on the image 50 where an object is detected is indicated, instead of the divided block information.

The imaging location is information (e.g., latitude, longitude, and altitude information) indicating a location where the image 50 is captured.

As described above, it can be said that the falsification inspection information 510 is extraction information used to extract the embedding information from the image.

In the first embodiment, part or all of the falsification inspection information 510 is encrypted and added to the output information. The falsification prevention processing unit 103 encrypts part or all of the falsification inspection information 510 with a public key, for example, by using the embedding unit 1032. In the example of FIG. 15, of the falsification inspection information 510, the processing method, the information about pixels and bits used for the processing, and the position information of the specific pixel are encrypted with the public key. Encryption is not limited to this example, and other information included in the falsification inspection information 510 may also be encrypted.

The encrypted falsification inspection information 510a is added to the image 50 as, for example, the header information 52.

Meanwhile, the falsification prevention code 520 is embedded in the image 50 as described with reference to FIGS. 7 to 14. Note that imaging location information indicating the location where the image 50 has been captured and imaging date and time information indicating an imaging date and time may be embedded in the image 50 by a predetermined method, or may be stored in the header information 52 or footer information (not illustrated) of the image 50.

As described above, in the first embodiment, it is determined whether to embed the embedding information, on the basis of the feature amount of the block 51, for each block 51, as the predetermined area, obtained by dividing the captured image 50. Therefore, it is possible to have strong resistance against the differential attack using the saturated image or the like. Furthermore, in the first embodiment, the embedding information is generated on the basis of the image (pixel values) of the target block 51a into which the embedding information is embedded. Therefore, when falsification is detected, it is possible to readily identify which part of the image 50 has been falsified. Furthermore, in the first embodiment, the information for extracting and restoring the embedding information from the image 50 is encrypted with the public key and added to the image 50 to generate the output information 500. Therefore, it is extremely difficult to analyze the embedding information embedded in the image 50.

(3-3. First Modification of First Embodiment)

Next, a first modification of the first embodiment will be described. In the first embodiment described above, as the predetermined area for determining whether to embed the embedding information, the block 51 obtained by dividing the image 50 is used. Meanwhile, in the modification of the first embodiment, the object detection is performed on the image 50, an area corresponding to the detected object is set as the predetermined area, and it is determined whether to embed the embedding information on the basis of the feature amount in the predetermined area.

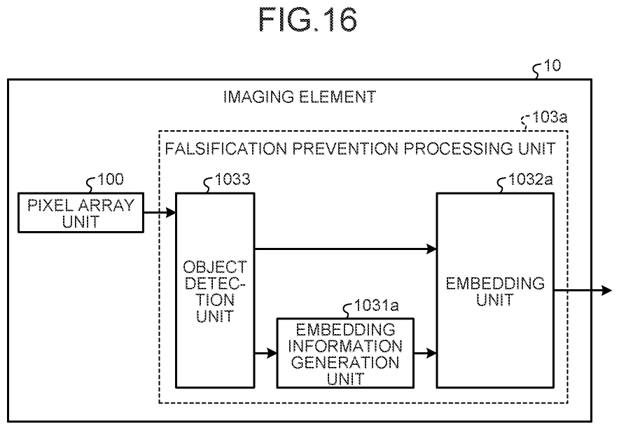

FIG. 16 is an exemplary functional block diagram illustrating functions of the imaging element according to the modification of the first embodiment. The configuration illustrated in FIG. 16 is provided with an object detection unit 1033 instead of the block division unit 1030, compared with the configuration of FIG. 6 according to the first embodiment.

The object detection unit 1033 detects, on the basis of the image information supplied from the pixel array unit 100, the object included in the image based on the image information. The detection of the object by the object detection unit 1033 may be performed by pattern matching for a predetermined object image prepared in advance, or may be performed using a model trained by machine learning with the predetermined object image as training data. Furthermore, for the detection of the object by the object detection unit 1033, facial recognition may be used.

The object detection unit 1033 passes information indicating an object detection area in the image that includes the detected object, to an embedding information generation unit 1031a and an embedding unit 1032a, together with the image. At this time, as the object detection area, a minimum rectangular region including the detected object may be used, or a rectangular region having a predetermined margin compared with the minimum rectangular region may be used. In addition, the object detection unit 1033 passes an object detection value indicating a likelihood of the detected object, to the embedding information generation unit 1031a.

The embedding information generation unit 1031a performs threshold determination on the object detection values passed from the object detection unit 1033, and generates the embedding information, on the basis of pixel information about an object detection area having an object detection value exceeding the threshold. The embedding information generation unit 1031a passes the information indicating the object detection area and the corresponding embedding information, to the embedding unit 1032a.

The embedding unit 1032a embeds the embedding information at a predetermined position of a specific pixel in the object detection area, on the basis of the image and the information indicating the object detection area that are passed from the object detection unit 1033, the information indicating the object detection area and the corresponding embedding information that are passed from the embedding information generation unit 1031a. Here, the position of the specific pixel in the object detection area can be determined in advance as, for example, a relative pixel position with respect to upper and lower ends and left and right ends of the object detection area which is the rectangular region.

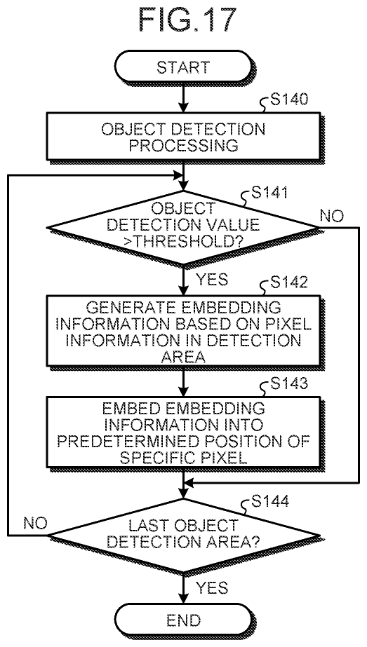

FIG. 17 is an exemplary flowchart illustrating an embedding process for embedding information according to the first modification of the first embodiment.

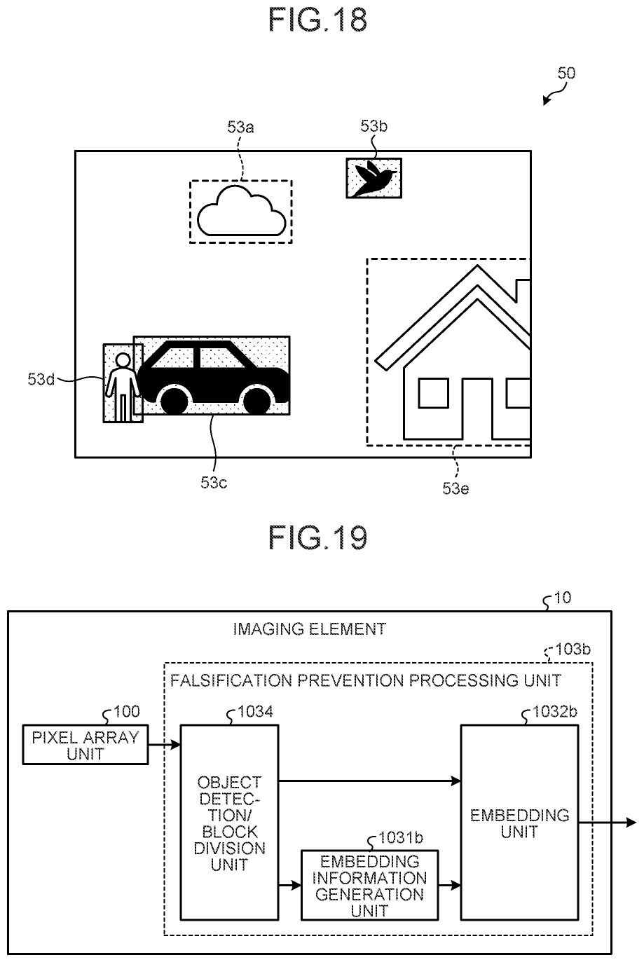

In Step S140, the falsification prevention processing unit 103 performs object detection processing of detecting the object included in the image based on the image information supplied from the pixel array unit 100, by using the object detection unit 1033. FIG. 18 is a schematic diagram illustrating an example of a result of the object detection processing on an image by an object detection unit 1033, according to the first modification of the first embodiment. The example of FIG. 18 illustrates a state in which the objects 53a, 53b, 53c, 53d, and 53e are detected in the image 50.

In the next Step S141, the falsification prevention processing unit 103 determines whether the object detection value indicating the likelihood exceeds a threshold, for one of the objects detected in Step S140, by using the object detection unit 1033. When the falsification prevention processing unit 103 determines that the object detection value is equal to or less than the threshold (Step S141, “No”), the process proceeds to Step S144.

On the other hand, when the falsification prevention processing unit 103 determines that the object detection value exceeds the threshold (Step S141, “Yes”), the process proceeds to Step S142. In the example of FIG. 18, the objects 53b, 53c, and 53d having the object detection areas represented by filling indicate objects each having an object detection value exceeding the threshold, and the objects 53a and 53e indicate objects each having an object detection value equal to or lower than the threshold.

In Step S142, the embedding information generation unit 1031a generates the embedding information, on the basis of the pixel information (pixel value) in each of the object detection areas including the object having an object detection value exceeding the threshold. Here, the method described in Step S103 of the flowchart of FIG. 7 can be applied to the generation of the embedding information.

In the next Step S143, the falsification prevention processing unit 103 embeds the embedding information generated in Step S142 into the predetermined position of the specific pixel in the object detection area, by using the embedding unit 1032. Note that the processing is skipped for the object detection areas that are not the target for embedding the embedding information (the object detection areas including the objects having an object detection value equal to or less than the threshold).

In the next Step S144, the falsification prevention processing unit 103 determines whether the object detection area processed in Steps S141 to S143 is the last object detection area processed in the image 50. When the falsification prevention processing unit 103 determines that the object detection area is not the last object detection area (Step S144, “No”), the process returns to Step S141 and the processing of a next object detection area in the image 50 is performed. On the other hand, when the falsification prevention processing unit 103 determines that the object detection area is the last object detection area (Step S144, “Yes”), a series of process steps according to the flowchart of FIG. 17 is finished.

As described above, setting the object detection area including the object having an object detection value exceeding the threshold as a target area for generation and embedding of the embedding information narrows the target area for generation and embedding of the embedding information is narrowed, and a falsified portion can be more readily identified.

Note that, in Step S141 described above, on the basis of the comparison of the object detection value with the threshold, it is determined whether to set the object detection area as the target area for generation and embedding of the embedding information, but determination is not limited to this example. For example, it is also possible to determine whether to set the target area for embedding according to the type of the detected object (person, vehicle, cloud, bird, etc.).

(3-4. Second Modification of First Embodiment)

Next, a second modification of the first embodiment will be described. The second modification of the first embodiment is a combination of the first embodiment and the first modification of the first embodiment which are described above. In other words, in the second modification of the first embodiment, the image supplied from the pixel array unit 100 is divided into the blocks 51, object detection is performed on the image, and blocks 51, of the blocks 51, including at least part of the object detection area having an object detection value exceeding the threshold is set as the target blocks 51 into which the embedding information is embedded.

FIG. 19 is an exemplary functional block diagram illustrating functions of the imaging element according to the second modification of the first embodiment. The configuration illustrated in FIG. 19 is provided with an object detection/block division unit 1034 instead of the block division unit 1030, compared with the configuration of FIG. 6 according to the first embodiment.

On the basis of the image information supplied from the pixel array unit 100, the object detection/block division unit 1034 divides the image based on the image information into the blocks 51 and detects the object included in the image 50. For object detection method or the like, the method according to the first modification of the first embodiment described above can be applied directly, and the description thereof will be omitted here.

The object detection/block division unit 1034 passes the information indicating the object detection areas each including the detected object in the image and the image divided into the blocks 51, to an embedding information generation unit 1031b and an embedding unit 1032b. Furthermore, the object detection/block division unit 1034 also passes the object detection value corresponding to each object detection area, to the embedding information generation unit 1031b.

The embedding information generation unit 1031b performs threshold determination on the object detection value passed from the object detection unit 1033, and extracts an object detection area having an object detection value exceeding the threshold. Then, the embedding information generation unit 1031b extracts a block 51 including at least part of the extracted object detection area from the blocks 51 into which the image is divided.

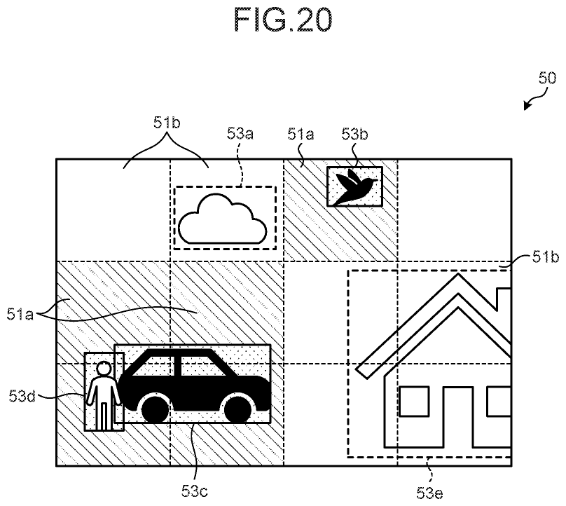

FIG. 20 is a schematic diagram illustrating an example of a result of object detection processing and block division processing on an image. The example of FIG. 20 illustrates a state in which the objects 53a, 53b, 53c, 53d, and 53e are detected in the image 50. In addition, in FIG. 20, the objects 53b, 53c, and 53d indicate objects each having an object detection value exceeding the threshold, and the objects 53a and 53e indicate objects each having an object detection value equal to or lower than the threshold.

Furthermore, in FIG. 20, of the blocks 51 obtained by dividing the image 50, the blocks 51a are blocks including at least part of the objects 53b, 53c, and 53d each having an object detection value exceeding the threshold. The blocks 51b are blocks in which the objects include no object detection areas. For example, the embedding information generation unit 1031b generates the embedding information, on the basis of the pixel value of each pixel that is included in each of the blocks 51a including at least part of the objects 53b, 53c, and 53d in which the object detection value exceeds the threshold.

The embedding information generation unit 1031b passes information indicating the blocks 51a and the embedding information corresponding to each block 51a, to the embedding unit 1032b.

The embedding unit 1032a embeds the embedding information into a predetermined position of the specific pixel of each block 51a, on the basis of the image passed from the object detection/block division unit 1034, the information about each target block 51a into which the embedding information is embedded, and the embedding information corresponding to each block 51a.

As described above, according to the second modification of the first embodiment, each block 51a including at least part of the object detection area based on the object detection is set as the target block into which the embedding information is embedded, and thus, the falsified portion can be readily identified as in the first modification of the first embodiment described above. In addition, a larger area in which the embedding information can be embedded is provided as compared with the first modification of the first embodiment described above, and it is possible to embed the embedding information having a larger data amount.

### 4. Second Embodiment of Present Disclosure

Next, a second embodiment of the present disclosure will be described. The second embodiment of the present disclosure is an example of using the image included in the output information 500 into which the embedding information has been embedded according to the first embodiment or the modifications thereof. In the second embodiment, the embedding information is extracted from the output information 500 and the presence or absence of falsification of the image is detected on the basis of the extracted embedding information.

(4-1. Existing Technology)

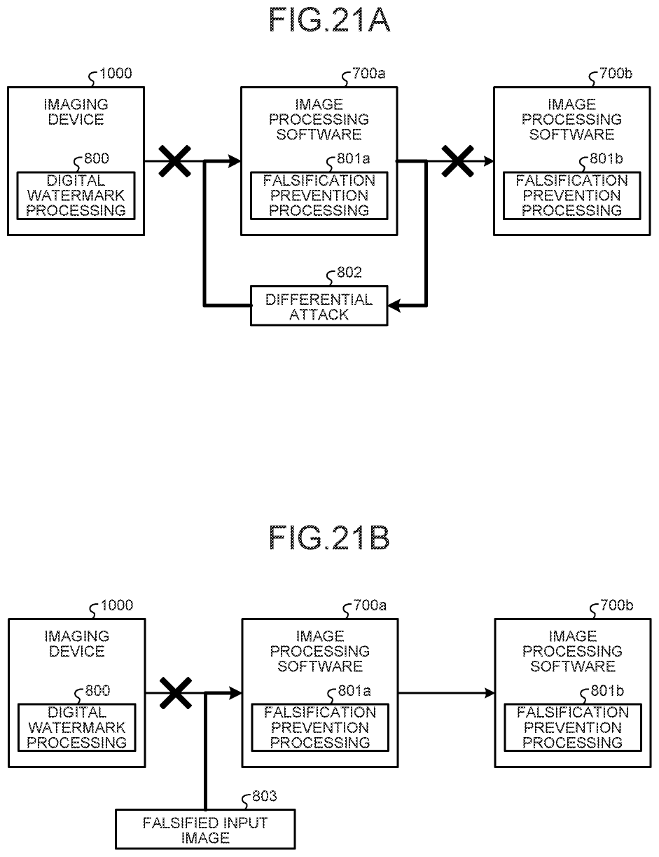

Prior to the description of the second embodiment, for ease of understanding, an existing technology related to falsification prevention will be schematically described. FIGS. 21A and 21B are each schematic diagram illustrating a problem of a falsification prevention technology according to an existing technology.

FIG. 21A schematically illustrates an example in which a falsification prevention method is analyzed by differential attack. An imaging device 1000 generates output information by embedding digital watermark information for preventing falsification into a captured image, according to digital watermark processing 800. The output information is input to, for example, image processing software 700a installed in an information processing apparatus/image processing apparatus such as a personal computer (PC).

For example, the image processing software 700a extracts the digital watermark information from the output information having been input according to falsification prevention processing 801a, and compares the extracted digital watermark information with digital watermark information obtained in advance. When both information match each other, the image processing software 700a determines that the output information (image) is not been falsified and outputs the output information (image) from the PC. The output information output from the PC is transmitted, for example, to another PC, and is subjected to falsification prevention processing 801b similarly by image processing software 700b.

In such a configuration, when a saturated image or an image captured with low noise and low gain is input to the image processing software 700a, there is a possibility that the position where the digital watermark information is embedded and the embedded digital watermark information are analyzed due to comparison of the input image with the output image by a differential attack 802.

FIG. 21B schematically illustrates an example in which the falsification prevention processing is broken by takeover. In the example of FIG. 21B, not the image captured by the imaging device 1000 but a falsified input image 803 is input to the image processing software 700a. As described above, when the input image 803 input to the image processing software 700a is an image that has been taken over, it is impossible to prove that the output image output from the image processing software 700a is not falsified.

(4-2. Configuration According to Second Embodiment)

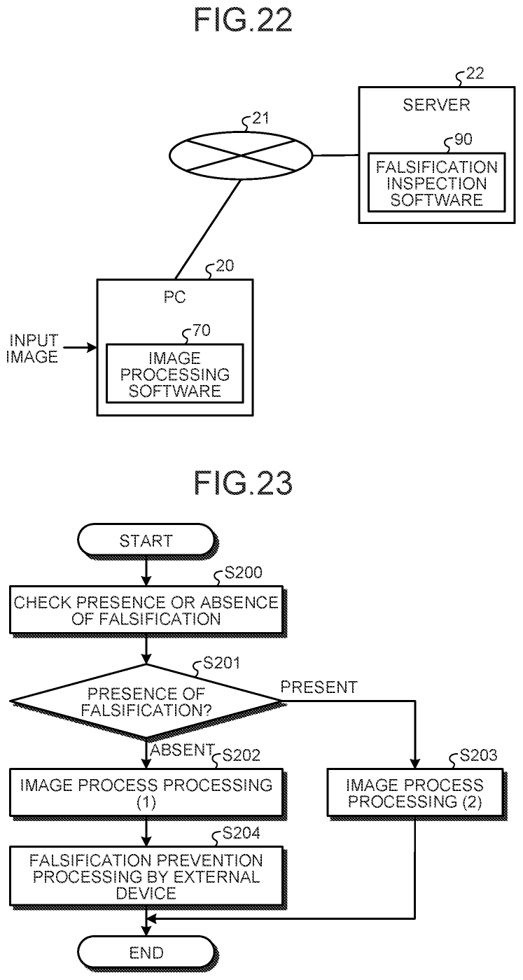

FIG. 22 is a diagram illustrating an exemplary configuration for falsification detection and prevention, according to the second embodiment.

An input image is input, for example, to a personal computer (PC) 20 as an image processing apparatus. This input image is data that has a configuration similar to that of the output image 500 described with reference to FIG. 15 and to which the encrypted falsification inspection information 510a is added as the header information 52. The PC 20 includes image processing software 70 that has functions according to the second embodiment. The PC 20 is communicable with a server 22 as the information processing apparatus via a network 21 such as the Internet or a local area network (LAN). The server 22 includes falsification inspection software 90 for performing falsification inspection according to the second embodiment.

FIG. 23 is an exemplary flowchart schematically illustrating a falsification detection and prevention process according to the second embodiment. Prior to the process according to the flowchart of FIG. 23, the PC 20 transmits the input image to the server 22 via the network 21, by using the image processing software 70.

The server 22 decrypts the encrypted falsification inspection information 510a included in the input image with a secret key, by using the falsification inspection software 90. The server 22 checks the presence or absence of falsification of the output image 500, on the basis of the falsification inspection information 510 obtained by decrypting the encrypted falsification inspection information 510a, by using the falsification inspection software 90 (Step S200).

The server 22 transmits a result of the checking of the presence or absence of falsification by the falsification inspection software 90, to the PC 20 via the network 21. The result of the checking of the presence or absence of falsification is acquired by the image processing software 70 in the PC 20. In Step S201, the PC 20 determines whether the acquired result of the checking of the presence or absence of falsification indicates the presence of falsification, by using the image processing software 70. When the PC 20 determines that the result of the checking indicates the absence of falsification, by using the image processing software 70 (Step S201, “absent”), the process proceeds to Step S202.

In Step S202, the PC 20 can perform image process processing (1) on the input image corresponding to the result of the checking by using the image processing software 70. Here, in the image process processing (1), processing that does not correspond to falsification of the input image is performed. As such processing, contrast correction, white balance adjustment, image format conversion, and the like for the image can be considered.

In the next Step S204, the PC 20 performs falsification prevention processing for preventing falsification by an external device, on the input image, by using the image processing software 70. Here, as the falsification prevention processing, the processing of generating and embedding the embedding information according to the first embodiment or the modifications thereof described above can be applied. After the processing of Step S204, a series of process steps according to the flowchart of FIG. 23 is finished.

On the other hand, when the PC 20 determines that the result of the checking indicates the presence of falsification, by using the image processing software 70 (Step S201, “present”), the process proceeds to Step S203. In Step S203, the image processing software 70 can perform image process processing (2) on the input image corresponding to the result of the checking. In this case, the input image has already been falsified, and therefore, any processing can be performed as the image process processing (2). The image processing software 70 does not perform the falsification prevention processing on the image subjected to the image process processing (2).

(4-3. Details of Processing According to Second Embodiment)

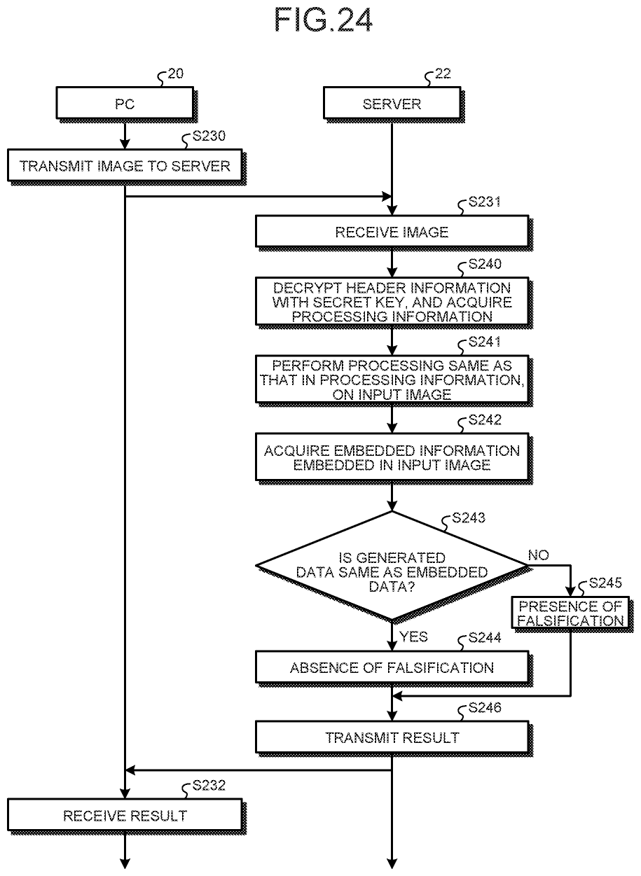

Next, the processing according to the second embodiment will be described in more detail. FIG. 24 is an exemplary flowchart illustrating the processing according to the second embodiment in more detail. The flowchart of FIG. 24 illustrates the processing of Step S200 in the flowchart of FIG. 23 described above in more detail.

In the flowchart of FIG. 24, in Step S230, the PC 20 transmits the input image to the server 20. In this input image, the encrypted falsification inspection information 510a described with reference to FIG. 15 is added as the header information 52.

The server 22 receives the input image transmitted from the PC 20 (Step S231). In Step S240, the server 22 decrypts the header information 52 of the received input image with the secret key by using the falsification inspection software 90 to restore the falsification inspection information 510. Then, the falsification inspection software 90 acquires processing information included in the falsification inspection information 510, such as the processing method, information about pixels and bits used for the processing, and position information of the specific pixel.

In the next Step S241, the server 22 performs processing of generating the embedding information on the input image received in Step S231, according to the processing information acquired in Step S240 by using the falsification inspection software 90. In other words, the processing is the same as the processing of generating the embedding information performed in the falsification prevention processing unit 103 of the imaging device 1.

In the next Step S242, the server 22 acquires the embedded information that has been embedded in the input image, on the basis of the processing information acquired in Step S240, from the input image received from the PC 20 in Step S231, by using the falsification inspection software 90.

In the next Step S243, the server 22 compares the embedding information generated in Step S241 with the embedded information acquired from the input image in Step S242 and determines whether the generated embedding information and the acquired embedded information are the same, by using the falsification inspection software 90. When the server 22 determines that the generated embedding information and the acquired embedding information are the same, by using the falsification inspection software 90 (Step S243, “Yes”), the process proceeds to Step S244, and it is determined that the image received in Step S231 is not falsified (absence of falsification).

On the other hand, when the server 22 determines that the generated embedding information and the acquired embedding information are not the same, by using the falsification inspection software 90 (Step S243, “No”), the process proceeds to Step S245, and it is determined that the image received in Step S231 is falsified (presence of falsification).

After the processing of Step S244 or Step S245, the process proceeds to Step S246, and the server 22 transmits the result of the determination in Step S244 or Step S245, to the PC 20, by using the falsification inspection software 90. This result of the determination is received by the PC 20 in Step S232, and is input to the image processing software 70.

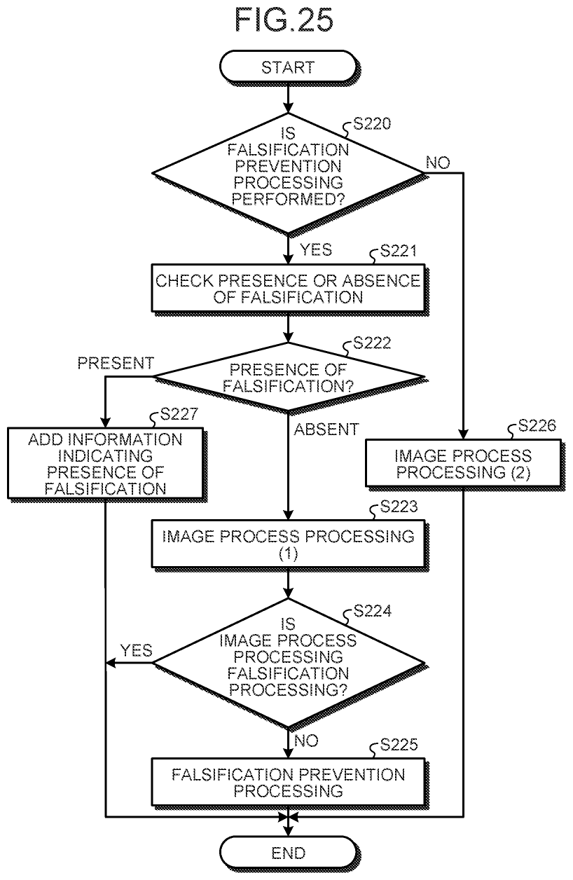

FIG. 25 is an exemplary flowchart illustrating processing in the PC 20 that has received the result of determination of the presence or absence of falsification from the server 22, according to the second embodiment. The processing according to the flowchart of FIG. 25 is performed as the processing of Step S201 and subsequent steps in the flowchart of FIG. 23 described above. Furthermore, in the flowchart of FIG. 25, the input image transmitted from the PC 20 to the server 22 in Step S230 in the flowchart of FIG. 24 described above is a processing target.

In Step S220, the PC 20 determines whether the target input image has been subjected to the falsification prevention processing, on the basis of, for example, the header information 52, by using the image processing software 70. When the PC 20 determines that the target input image has not been subjected to the falsification prevention processing, by using the image processing software 70 (Step S220, “No”), the process proceeds to Step S226. In this case, it cannot be guaranteed that the input image has not been falsified, and therefore, in Step S226, any image process processing can be performed by the image process processing (2). After the processing of Step S226, the PC 20 finishes a series of process steps according to the flowchart of FIG. 25 without performing further falsification prevention processing.

On the other hand, when the PC 20 determines that the falsification prevention processing has been performed, by using the image processing software 70 in Step S220 (Step S220, “Yes”), the process proceeds to Step S221.

In Step S221, the PC 20 checks whether the input image has been falsified, on the basis of the result of the determination transmitted from the server 22 in Step S232 of the flowchart of FIG. 24, by using the image processing software 70. In the next Step S222, when the PC 20 determines the presence of falsification on the basis of the result of the determination by using the image processing software 70 (Step S222, “present”), the processing proceeds to Step S227.

In Step S227, the PC 20 adds information indicating the “presence of falsification” for the input image, by using the image processing software 70, and finishes a series of process steps according to the flowchart of FIG. 25.

On the other hand, when the PC 20 determines the absence of falsification on the basis of the result of the determination, by using the image processing software 70 (Step S222, “absent”), the process proceeds to Step S223.

In Step S223, the PC 20 can perform the image process processing (1) that does not correspond to falsification of the image which has been described above on the input image corresponding to the result of the checking, by using the image processing software 70. In the next Step S224, the PC 20 determines whether the image process processing performed in Step S223 corresponds to falsification processing, by using the image processing software 70. When the PC determines that the image process processing (1) performed in Step S223 corresponds to the falsification processing, by using the image processing software 70 (Step S224, “Yes”), a series of process steps according to the flowchart of FIG. 25 is finished.

On the other hand, when the PC 20 determines that the image process processing (1) performed in Step S223 does not correspond to the falsification processing, by using the image processing software 70 (Step S224, “No”), the process proceeds to Step S225. In Step S225, the PC 20 performs the falsification prevention processing on the input image by using the image processing software 70. Here, the processing described in the first embodiment or the modifications thereof described above can be applied to the falsification prevention processing. The falsification prevention processing may be performed, not limited to this configuration, by another method.

As described above, in the second embodiment, the encrypted falsification inspection information 510a obtained by encrypting the falsification inspection information 510 used to determine the presence or absence of falsification of the image with the public key is transmitted, from the PC 20 as the image processing apparatus, to the server 22 as the information processing apparatus. The server 22 decrypts the encrypted falsification inspection information 510a with the secret key, and processing of checking the presence or absence of falsification with the decrypted falsification inspection information 510 is performed on the server 22. This configuration prevents external decryption of the information of the encrypted falsification inspection information 510a, and the presence or absence of falsification of the image can be checked highly confidentially.

(4-4. Modifications of Second Embodiment)

Next, a modification of the second embodiment will be described. The modification of the second embodiment is an example in which only information necessary for checking falsification is transmitted from the PC 20 to the server 22 without transmitting the entire image. Transmission of only intermediate information from the PC 20 to the server 22 as described above can reduce a load on the network 21.

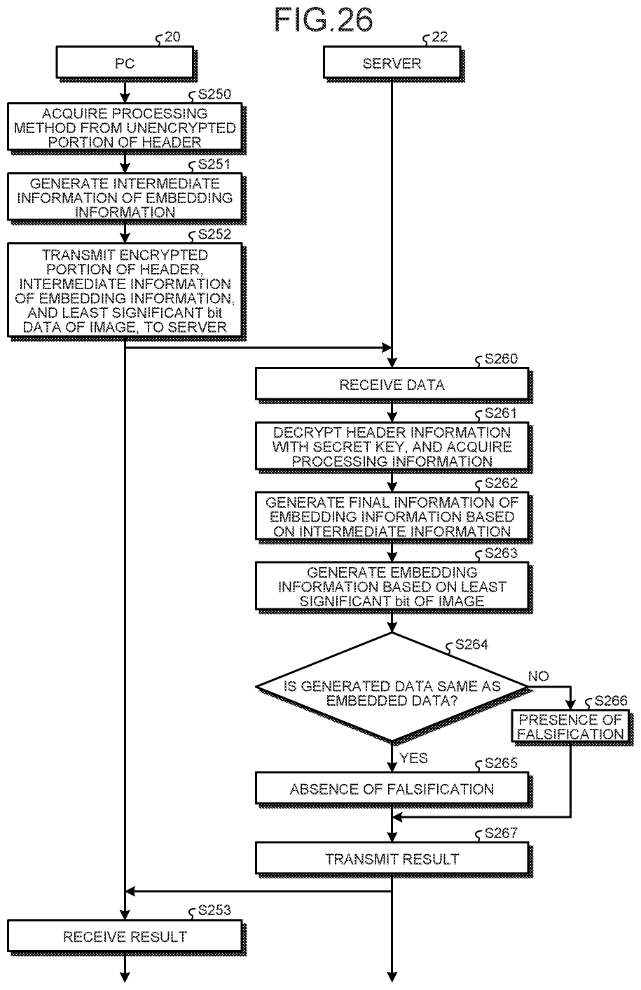

FIG. 26 is an exemplary flowchart illustrating processing according to the modification of the second embodiment in more detail. The flowchart of FIG. 26 illustrates the processing of Step S200 in the flowchart of FIG. 23 described above in more detail.

In the flowchart of FIG. 26, in Step S250, the PC 20 acquires the processing method (threshold information, divided block information, etc.) from an unencrypted portion in the header information 52 of the input image. In the next Step S251, the PC 20 generates the intermediate information of the embedding information, from the information acquired in Step S250 by using the image processing software 70.

In the next step S252, the PC 20 acquires the encrypted falsification inspection information 510a included in the header information 52 of the input image by using the image processing software 70, and the acquired encrypted falsification inspection information 510a, the intermediate information of the embedding information generated in step S251, and the data of the least significant bit of the input image (when the embedding information is embedded in the least significant bit) are transmitted to the server 22.

In Step S260, the server 22 receives each piece of information transmitted from the PC 20 in Step S252. Each piece of the received information is input to the falsification inspection software 90.

In the next step S261, the server 22 decrypts the encrypted falsification inspection information 510a, of the pieces of information received in step S260, with the secret key by using the falsification inspection software 90, and restores the falsification inspection information 510. Then, the falsification inspection software 90 acquires processing information included in the falsification inspection information 510, such as the processing method, information about pixels and bits used for the processing, and position information of the specific pixel.

In the next Step S262, the server 22 acquires the intermediate information from the pieces of information received from the PC 20 in Step S260, by using the falsification inspection software 90, and a final value of the embedding information is generated on the basis of the acquired intermediate information and the processing information acquired in Step S261. The final value of the embedding information generated here corresponds to the embedding information embedded in the output information 500 that is captured, for example, by the imaging device 1 and that is generated in the first embodiment or the modifications thereof described above by the falsification prevention processing unit 103 included in the imaging device 1, and is information that is guaranteed as the image not falsified.

In the next Step S263, the server 22 reproduces the embedding information, from the information of the least significant bit of the input image, of the pieces of information received from the PC 20 in Step S260 and the position information of the specific pixel acquired in Step S261, by using the falsification inspection software 90. The embedding information reproduced here corresponds to the embedding information that has been embedded in the input image input to the PC 20.

In the next Step S264, the server 22 compares the embedding information as the final value generated in Step S262 with the embedding information reproduced in Step S263, by using the falsification inspection software 90, and it is determined whether the generated embedding information as the final value is the same as the reproduced embedding information. When the server 22 determines that the generated embedding information as the final value and the reproduced embedding information are the same, by using the falsification inspection software 90 (Step S264, “Yes”), the process proceeds to Step S265, and it is determined that the image received in Step S260 is not falsified (absence of falsification).

On the other hand, when the server 22 determines that the generated embedding information as the final value and the reproduced embedding information are not the same, by using the falsification inspection software 90 (Step S264, “No”), the process proceeds to Step S266, and it is determined that the image received in Step S260 is falsified (presence of falsification).

After the processing of Step S265 or Step S266, the process proceeds to Step S267, and the server 22 transmits the result of the determination in Step S265 or Step S266, to the PC 20, by using the falsification inspection software 90. This result of the determination is received by the PC 20 in Step S253, and is input to the image processing software 70.

The subsequent processing in the PC 20 is the same as the processing described with reference to FIG. 25, and the description thereof will be omitted here.

It should be noted that the effects described herein are merely examples and are not intended to restrict the present disclosure, and other effects may be provided.

Note that the present technology can also have the following configurations.
(1) An imaging element comprising:
   an imaging unit that outputs image information according to received light;
   an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded; and
   an embedding unit that embeds the embedding information, into the predetermined area.
(2) The imaging element according to the above (1), wherein
   the embedding information generation unit
   sets each of blocks obtained by dividing the image based on the image information, as the predetermined area.
(3) The imaging element according to the above (1), wherein
   the embedding information generation unit
   sets an area where a predetermined object is detected from the image is set as the predetermined area.
(4) The imaging element according to the above (1), wherein
   the embedding information generation unit
   sets, as the predetermined area, a block including at least part of a detection area where a predetermined object is detected from the image, of blocks obtained by dividing the image based on the image information.
(5) The imaging element according to any one of the above (1) to (4), wherein
   the embedding unit
   sets some of a plurality of pixels included in the predetermined area, as target pixels into which the embedding information is embedded.
(6) The imaging element according to any one of the above (1) to (5), wherein
   the embedding information generation unit
   performs the determination by using, as the feature amount, a dispersion of values in the predetermined area, the values being obtained from bit strings each not including at least a least significant bit, in pixel values of the plurality of pixels included in the predetermined area.
(7) The imaging element according to any one of the above (1) to (6), wherein
   the embedding information generation unit
   generates the embedding information, for each predetermined area, based on an image included in the predetermined area.
(8) The imaging element according to the above (7), wherein
   the embedding information generation unit
   generates the embedding information, based on a calculation result of calculation using a pixel value of each of a plurality of pixels included in the predetermined area.
(9) The imaging element according to the above (8), wherein
   the embedding information generation unit
   generates, as the embedding information, values of a predetermined number of bits from a least significant bit, of values obtained by the calculation.
(10) The imaging element according to any one of the above (1) to (9), wherein
   the embedding unit
   adds extraction information for extracting, from the image information in which the embedding information has been embedded, the embedding information, to the image information to generate output information.
(11) The imaging element according to the above (10), wherein
   the embedding unit
   encrypts the extraction information and adds the encrypted extraction information to the image information to generate the output information.
(12) The imaging element according to the above (10) or (11), wherein
   the extraction information includes:
   generation method information that indicates a generation method by which the embedding information generation unit has generated the embedding information;
   generation information, of the image information, that indicates information used to generate the embedding information by the embedding information generation unit; and
   position information that indicates a position into which the embedding information is embedded in the image information.
(13) An imaging method performed by a processor, comprising:
   an imaging step of outputting image information according to received light;
   an embedding information generation step of obtaining a feature amount of a predetermined area of an image based on the image information, determining whether to embed embedding information in the predetermined area based on the feature amount, and generating the embedding information based on the image information of the predetermined area into which the embedding information is determined to be embedded; and
   an embedding step of embedding the embedding information, into the predetermined area.
(14) An imaging device comprising:
   an imaging unit that outputs image information according to received light;
   an optical unit that guides light from a subject to the imaging unit;
   an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded;
   an embedding unit that embeds the embedding information, into the predetermined area; and
   a recording unit that records the image information into which the embedding information is embedded by the embedding unit.
(15) An image processing system comprising:
   an image processing apparatus; and
   an information processing apparatus that is connected to the image processing apparatus via a network,
   wherein the information processing apparatus includes
   a falsification detection unit that, based on a feature amount of a predetermined area of an image, acquires image information of an image for which whether to embed embedding information in the predetermined area, from the image processing apparatus through the network, extracts the embedding information from the acquired image information, detects presence or absence of falsification against the image information based on the extracted embedding information, adds falsification detection information indicating presence or absence of the detected falsification to the image information, and transmits the falsification detection information to the image processing apparatus, and
   the image processing apparatus includes
   an image processing unit that, when the falsification presence/absence information added to the image information transmitted from the information processing apparatus indicates absence of the falsification, performs image processing on the image information, performs image falsification prevention processing on the image information subjected to the image processing, and, when the falsification presence/absence information indicates presence of the falsification, adds information indicating presence of the falsification in the image information.

### REFERENCE SIGNS LIST

1 IMAGING DEVICE
10 IMAGING ELEMENT
12 RECORDING UNIT
13 OUTPUT UNIT
20 PC
22 SERVER
50 IMAGE
51, 51a, 51b BLOCK
52 HEADER INFORMATION
53a, 53b, 53c, 53d, 53e OBJECT
60 PIXEL
60em SPECIFIC PIXEL
70 IMAGE PROCESSING SOFTWARE
90 FALSIFICATION INSPECTION SOFTWARE
100 PIXEL ARRAY UNIT
103, 103a, 103b FALSIFICATION PREVENTION PROCESSING UNIT
500 OUTPUT INFORMATION
510 FALSIFICATION INSPECTION INFORMATION
510a ENCRYPTED FALSIFICATION INSPECTION INFORMATION
1030 BLOCK DIVISION UNIT
1031, 1031a, 1031b EMBEDDING INFORMATION GENERATION UNIT
1032, 1032a, 1032b EMBEDDING UNIT
1033 OBJECT DETECTION UNIT
1034 OBJECT DETECTION/BLOCK DIVISION UNIT

1. An imaging element comprising:
an imaging unit that outputs image information according to received light;
an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded; and
an embedding unit that embeds the embedding information, into the predetermined area.

2. The imaging element according to claim 1, wherein
the embedding information generation unit
sets each of blocks obtained by dividing the image based on the image information, as the predetermined area.

3. The imaging element according to claim 1, wherein
the embedding information generation unit
sets an area where a predetermined object is detected from the image is set as the predetermined area.

4. The imaging element according to claim 1, wherein
the embedding information generation unit
sets, as the predetermined area, a block including at least part of a detection area where a predetermined object is detected from the image, of blocks obtained by dividing the image based on the image information.

5. The imaging element according to claim 1, wherein
the embedding unit
sets some of a plurality of pixels included in the predetermined area, as target pixels into which the embedding information is embedded.

6. The imaging element according to claim 1, wherein
the embedding information generation unit
performs the determination by using, as the feature amount, a dispersion of values in the predetermined area, the values being obtained from bit strings each not including at least a least significant bit, in pixel values of the plurality of pixels included in the predetermined area.

7. The imaging element according to claim 1, wherein
the embedding information generation unit
generates the embedding information, for each predetermined area, based on an image included in the predetermined area.

8. The imaging element according to claim 7, wherein
the embedding information generation unit
generates the embedding information, based on a calculation result of calculation using a pixel value of each of a plurality of pixels included in the predetermined area.

9. The imaging element according to claim 8, wherein
the embedding information generation unit
generates, as the embedding information, values of a predetermined number of bits from a least significant bit, of values obtained by the calculation.

10. The imaging element according to claim 1, wherein
the embedding unit
adds extraction information for extracting, from the image information in which the embedding information has been embedded, the embedding information, to the image information to generate output information.

11. The imaging element according to claim 10, wherein
the embedding unit
encrypts the extraction information and adds the encrypted extraction information to the image information to generate the output information.

12. The imaging element according to claim 10, wherein
the extraction information includes:
generation method information that indicates a generation method by which the embedding information generation unit has generated the embedding information;
generation information, of the image information, that indicates information used to generate the embedding information by the embedding information generation unit; and
position information that indicates a position into which the embedding information is embedded in the image information.

13. An imaging method performed by a processor, comprising:
an imaging step of outputting image information according to received light;
an embedding information generation step of obtaining a feature amount of a predetermined area of an image based on the image information, determining whether to embed embedding information in the predetermined area based on the feature amount, and generating the embedding information based on the image information of the predetermined area into which the embedding information is determined to be embedded; and
an embedding step of embedding the embedding information, into the predetermined area.

14. An imaging device comprising:
an imaging unit that outputs image information according to received light;
an optical unit that guides light from a subject to the imaging unit;
an embedding information generation unit that obtains a feature amount of a predetermined area of an image based on the image information, determines whether to embed embedding information in the predetermined area based on the feature amount, and generates the embedding information based on the image information of the predetermined area into which the embedding information is determined to be embedded;
an embedding unit that embeds the embedding information, into the predetermined area; and
a recording unit that records the image information into which the embedding information is embedded by the embedding unit.

15. An image processing system comprising:
an image processing apparatus; and
an information processing apparatus that is connected to the image processing apparatus via a network,
wherein the information processing apparatus includes
a falsification detection unit that, based on a feature amount of a predetermined area of an image, acquires image information of an image for which whether to embed embedding information in the predetermined area, from the image processing apparatus through the network, extracts the embedding information from the acquired image information, detects presence or absence of falsification against the image information based on the extracted embedding information, adds falsification detection information indicating presence or absence of the detected falsification to the image information, and transmits the falsification detection information to the image processing apparatus, and
the image processing apparatus includes
an image processing unit that, when the falsification presence/absence information added to the image information transmitted from the information processing apparatus indicates absence of the falsification, performs image processing on the image information, performs image falsification prevention processing on the image information subjected to the image processing, and, when the falsification presence/absence information indicates presence of the falsification, adds information indicating presence of the falsification in the image information.
